(19) United States
(12) Patent Application Publication
(10) Pub. No.: US 2013/0258487 A1
(43) Pub. Date: Oct. 3, 2013

(54) LOW MASS WARPAGE FREE EYEPIECE

(71) Applicants: DONALD J. JANECZKO, Fincastle, VA (US); James E. Michalski, Saint Johns, FL (US)

(72) Inventors: DONALD J. JANECZKO, Fincastle, VA (US); James E. Michalski, Saint Johns, FL (US)

(73) Assignee: EXELIS, INC., MCLEAN, VA (US)

(21) Appl. No.: 13/435,038

(22) Filed: Mar. 30, 2012

(51) Int. Cl. G02B 25/00; G02B 27/01

(52) U.S. Cl. 359/630; 359/645

(57) ABSTRACT

An eyepiece for a night vision goggle (NVG) system includes a first lens element axially aligned with second and third lens elements. The first, second and third lens elements are sequentially positioned between a viewer and an object formed on a screen surface. The first lens element is formed as a doublet having two cemented elements. The second lens element includes a convex surface facing the doublet and a concave surface facing toward the third lens element. The third lens element includes a first convex surface facing the second lens element and a second convex surface facing the object. The second lens element is formed with two even aspheric surfaces comprised of only even coefficients and is substantially uniform in thickness.

### FIELD OF THE INVENTION

The present invention relates, in general, to an eyepiece or magnifier for viewing optics and, more particularly, to an eyepiece or magnifier for viewing optics used in night vision goggle (NVG) systems and head mounted displays.

### BACKGROUND OF THE INVENTION

Eyepieces and magnifiers have been in use for many years in telescopes, microscopes, and many other applications where the user needs to magnify an object. These optical systems consist of one or more lens elements distributed along the optical axis. These lens elements are used to allow the human eye to view the desired object closer than he or she can normally focus, and hence provide a magnified view of the object of interest.

An example of eyepieces and magnifiers is disclosed in U.S. Pat. No. 6,349,004, issued in 2002 to Fisher et al. (Fisher). As shown in FIG. 1 of Fisher, lens system 10 is used as a viewing optical system that includes a cemented doublet 22, 23 and a weak aspheric element 24 which, for example, is made of acrylic. The cemented doublet 22, 23 and aspheric element 24 are arranged to provide a collimated image of an object 20 at an exit pupil (EP) position 18. The cemented doublet includes a positive low dispersion crown glass lens element 22, which is cemented to a high dispersion flint lens element 23. The rear surface 25 of the single lens element 24 is spherical, whereas the front surface 26 is aspheric. The front surface 26 is also diffractive having a kinoform profile. The lens system 10 reduces chromatic aberrations and minimizes most of the monochromatic aberrations of the optics. By allowing the lens system 10 to produce an image on a curved surface, such as screen 20 of plate 21, optical performance is improved over other systems, because the system is able to control image blurring aberrations rather than control field curvature.

The aspheric lens of Fisher has a varying thickness (as a function of radial distance) and does not have a uniform cross-section. The disadvantage of having a varying thickness is that the cooling rate (as a function of radial lens distance) during manufacture is not constant. Non-uniform cooling rate in a non-uniform thickness of an aspheric lens results in an inhomogeneous index of refraction of the lens, which causes reduced image quality. In addition, aspheric lens 24, having a non-uniform cross-section, is costly to manufacture because it requires slow cooling to avoid warpage.

Similar problems exist with legacy and ENVG eyepieces, which are shown in FIGS. 2 and 3, respectively. FIG. 2 shows lens system 30 as a legacy eyepiece produced circa 1999. Lens system 30 also includes a cemented doublet 33 and an aspheric element 34, similar to Fisher. The aspheric element 34 includes a front spherical surface 36 and an aspheric rear surface 35. The image provided on curved screen 39 is imaged onto the eye's pupil (EP) 38.

FIG. 3 shows lens system 40 of an ENVG eyepiece produced circa 2004. Lens system 40 includes multiple lens elements 41, 42, 43 and 44. The aspheric lens element 42 has an aspheric rear surface 46 and a spherical front surface 45. The image provided on curved screen 49, which passes through NVG element 47 and the multiple lens elements 41, 42, 43 and 44, is focused at the EP plane 48. Similar to the Fisher lens system, the effects of non-uniform thicknesses of the aspheric lens element 42 limit the image qualities of lens system 40.

The present invention, as will be explained, provides a cost effective eyepiece/magnifier that increases image quality, because it is without any aspheric lens elements having non-uniform surfaces.

### SUMMARY OF THE INVENTION

To meet this and other needs, and in view of its purposes, the present invention is embodied in eyepieces/magnifiers. The present invention provides an eyepiece/magnifier including a cemented doublet and an aspheric element having a constant cross-section (concentric shell), arranged to provide a high quality image. In addition, the eyepiece/magnifier may be formed from individual lenses which have no flat surfaces and no diffractive surfaces. Furthermore, the eyepiece/magnifier may project a wide field of view from either a flat screen surface or a curved screen surface.

The present invention includes an eyepiece for a night vision goggle (NVG) system. The eyepiece includes a first lens element axially aligned with second and third lens elements. The first, second and third lens elements are sequentially positioned between a viewer and an object. The first lens element is formed as a doublet having two cemented surfaces. The second lens element includes a convex surface facing the doublet and a concave surface facing the third lens element. The third lens element includes a first convex surface facing the second lens element, and a second convex surface facing the object.

The convex and concave surfaces of the second lens element form a nearly concentric shell with a nearly uniform cross section, effectively resulting in a constant internal stress and reduced warpage.

The first lens element includes a convex surface facing the viewer, and a concave surface facing the second lens element.

The doublet includes a negative lens and a positive lens. The negative lens faces the viewer, and the positive lens faces the second lens element.

An image screen is aligned axially along an optical axis of the first, second and third lens elements for projecting light from the image screen, in sequence, toward the third, the second, and the first lens elements and toward the viewer.

A beam combiner is provided between the third lens and the object, in axial alignment along the optical axis. A display is provided substantially perpendicular to the optical axis. A light is emitted from the display and redirected by the beam combiner for viewing by the viewer.

The present invention also includes a night vision device having an image superimposed on a screen surface and an eye pupil (EP) plane for viewing the image. The night vision device includes a lens system comprising:

first, second and third lens elements sequentially located on an axial line between the EP and the screen surface,

the first lens element including a doublet having two cemented lens elements,

the second lens element including two even aspheric surfaces forming a nearly concentric shell with a nearly uniform cross section, and

the third lens element including a biconvex lens of oppositely facing symmetrical surfaces.

The screen surface may be a curved surface, and the two even aspheric surfaces may each be formed from only even coefficients.

It is understood that the foregoing general description and the following detailed description are exemplary, but are not restrictive, of the invention.

### BRIEF DESCRIPTION OF THE DRAWINGS

The invention may best be understood from the following detailed description when read in connection with the accompanying figures:

FIG. 1 is a conventional lens system comprised of a cemented doublet and an aspheric element.

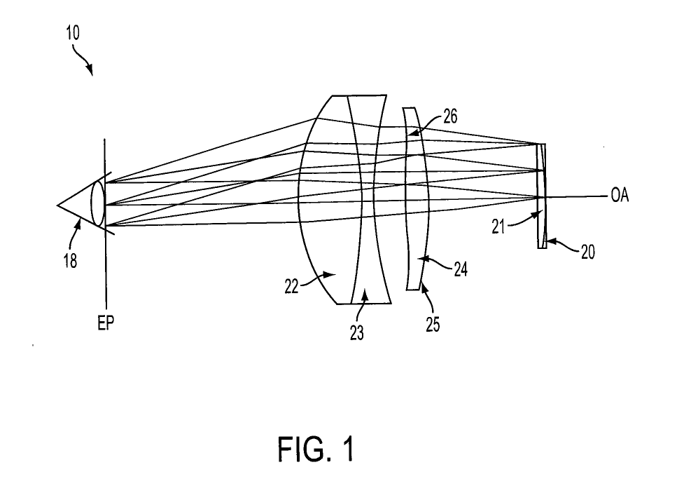

FIG. 2 is another conventional lens system comprised of a cemented doublet and an aspheric element.

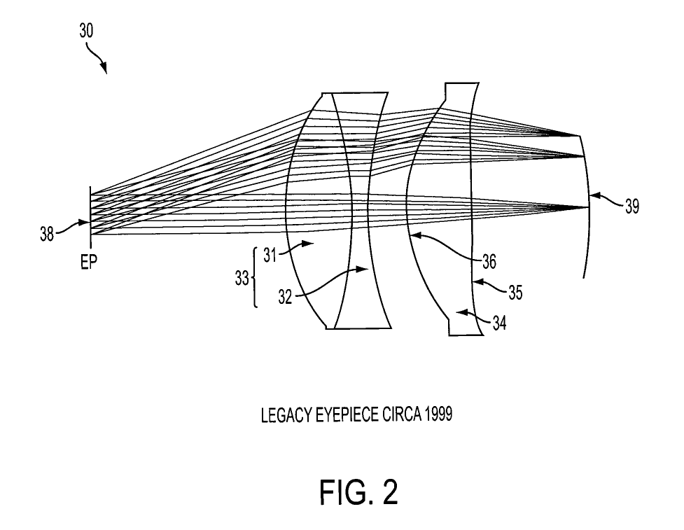

FIG. 3 is yet another conventional lens system comprised of several lenses, including an aspheric element.

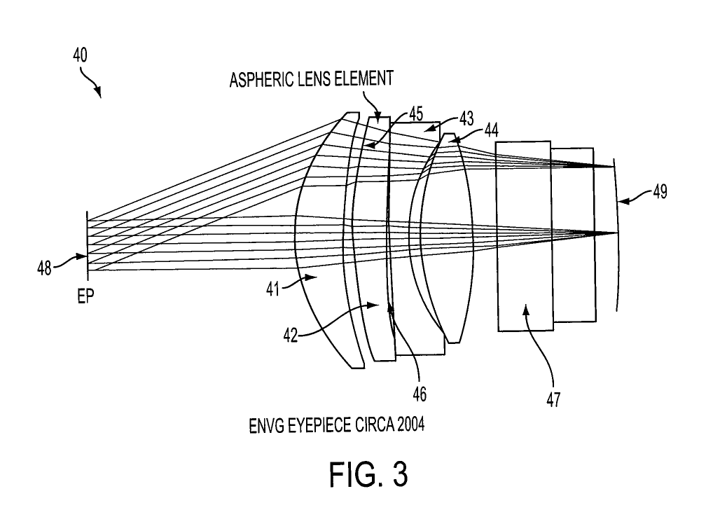

FIG. 4A is a lens system in accordance with an embodiment of the present invention.

FIG. 4B is the same lens system shown in FIG. 4A with the identification of surfaces corresponding to the prescription surfaces tabulated in FIG. 8.

FIG. 5 shows the configuration of a meniscus lens, identified in FIG. 4A as lens element 54.

FIG. 6 shows transverse ray aberrations of the lens system of FIG. 4A.

FIG. 7 shows a modulation transfer function (MTF) of the lens system of FIG. 4A.

FIG. 8 is a prescription for the lens system of FIG. 4B, in accordance with an embodiment of the present invention.

FIG. 9 is block diagram of a night vision goggle (NVG) system capturing images with two separate sensors, which are fused by a beam combiner for viewing, by way of the lens system of FIG. 4A, in accordance with an embodiment of the present invention.

### DETAILED DESCRIPTION OF THE INVENTION

Hereinafter, the embodiments of the present invention described below relate to a configuration of a low mass warpage free magnifier having a constant cross-section (concentric shell) of an aspheric lens element. The uniform cross-section of the lens element results in constant internal stress, whether the manufacturing process includes molding or machining, and thus avoids warpage. The present invention reduces image degrading aberrations present in conventional lens system and reduces astigmatism.

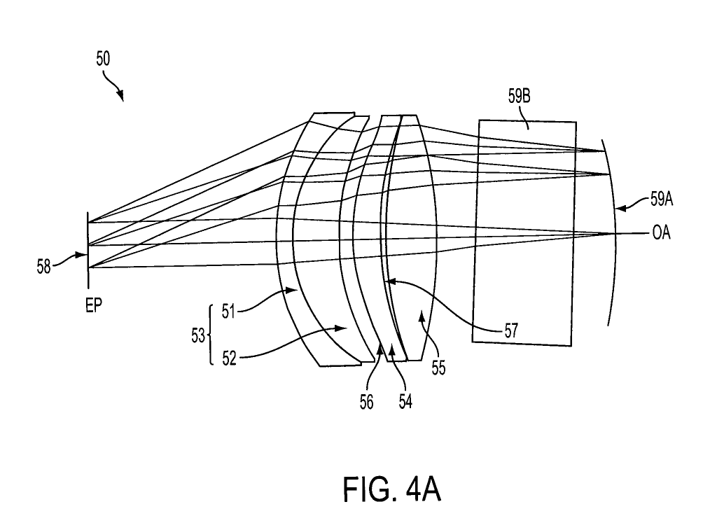

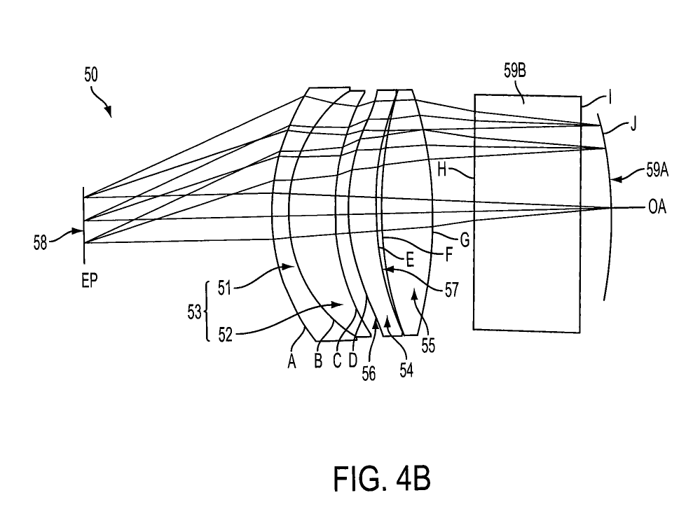

An embodiment of the present invention is shown in FIGS. 4A and 4B as lens system 50, also referred to herein as magnifier 50, or viewing optics 50. FIG. 4A is a cross-sectional view of lens system 50 aligned along a common optic axis (OA). When in use, as described below, all the optical elements aligned along the optical axis (OA) in FIG. 4A are communicating by way of light propagation. An eye pupil (EP) at a viewer's eye, designated as EP 58, is viewing an image 59A. The image 59A may be viewed on a curved screen 59A. As shown, lens system 50 includes three lens elements 53, 54 and 55. The first lens element 53 is a glass doublet and includes a cemented lens formed by bonding together a lens element 51 and a lens element 52. The second lens element 54 is a meniscus lens. The third lens element 55 is a biconvex lens. The first, second and third lens elements 53, 54 and 55 have positive refractive powers.

The image formed at eye pupil 58 (the viewer) is defined herein as an image formed at the front of lens system 50. The image formed on screen 59A is defined herein as an image formed at the rear of lens system 50. The image screen 59A is aligned axially along the optical axis (OA) of the first, second and third lens elements and projects light from image screen 59A, in sequence, toward the third, second, and first lens elements and then eye pupil 58. The light passing from image screen 59A to EP 58 does not pass through any aspheric surfaces. As shown in FIG. 4A, the first lens element 53 diverges light toward the second and third lens elements, while the second and third lens elements 54, 55 converge light emitted from the first lens element.

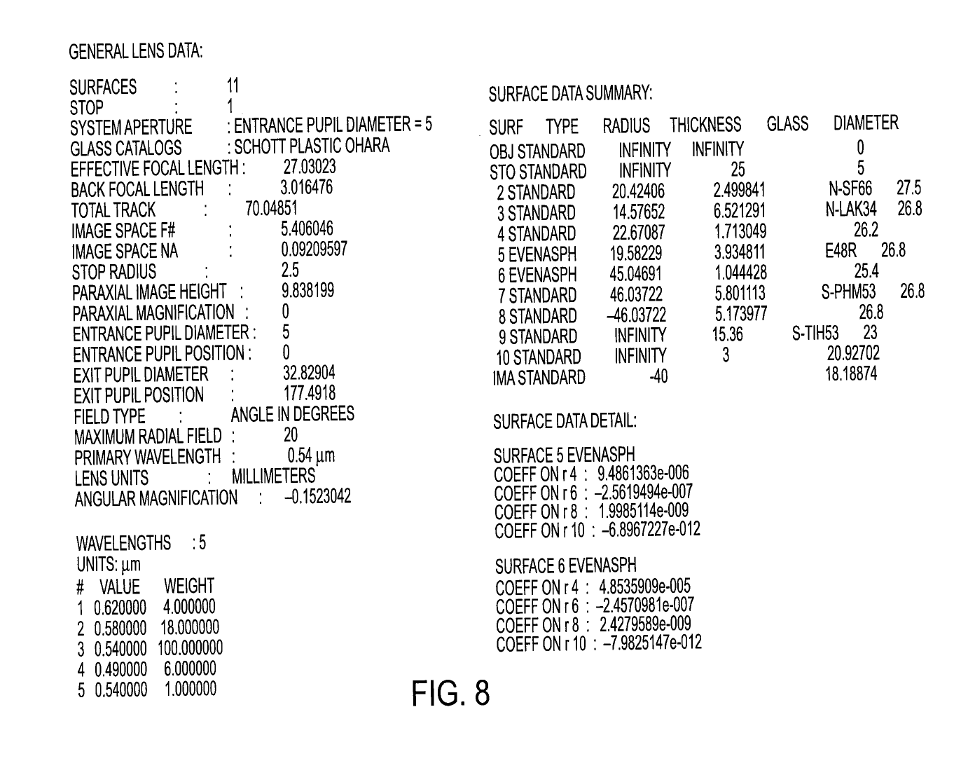

The second lens element 54 includes a front surface 56 and a rear surface 57. The front surface is an even aspheric surface and the rear surface is an even aspheric surface. These surfaces are tabulated in FIG. 8 as surfaces 5 and 6 (corresponding to surfaces D and E, respectively, in FIG. 4B). The surface details are also tabulated in FIG. 8 and include only even coefficients.

The second lens element 54 includes a convex surface 56 facing the first lens element 53 and a concave surface 57 facing away from the first lens element 53 and toward the third lens element 55. The convex and concave aspheric surfaces of the second lens element 54 form a nearly concentric shell with a nearly uniform cross section. The uniform cross-section of the second lens element 54 results in a nearly constant internal stress, regardless of the manufacturing processing techniques and, therefore, reduces much of the lens warpage.

The peripheral portions of the aspheric surface of the second lens element 54 may have a sagittal depth that is greater than a sagittal depth at any other portion of the aspheric surface. Furthermore, the aspheric surface of the second lens element 54 may have a distance of more than seven diopters from the surface of image 59A. Furthermore, the aspheric surface may be formed on any positive surface of the second lens element.

The lens elements 53, 54 and 55, shown in FIG. 4A, may be manufactured from a polymer material, such as acrylic. The optical properties of the polymer material may be similar to ordinary BK7 optical glass. The second lens element 54, however, may also be manufactured from other materials, such as polystyrene, cyclic olefin copolymer (COC), amorphous polyolefin (e.g., ZEONEX™ by Nippon Zeon Co, Ltd.), for example. Such polymer materials allow the second lens element 54 to be injection molded for cost effective manufacturing.

The lens system 50 is, thus, a cost effective eyepiece/magnifier with an aspheric lens element. The inventor discovered that an aspheric lens element may advantageously be used in an eyepiece to form a magnified image with excellent image quality and a wide field of view. The nearly constant cross-section of the aspheric lens element (concentric shell) allows rapid uniform cooling after molding, thereby reducing stress, birefringence, and inhomogeneity in the index of refraction. This results in improved image quality of the eyepiece, e.g., maintaining a reasonably flat modulation transfer function (MTF) and reducing aberrations. A uniform aspheric thickness also reduces swimming/parallax as the eye moves.

FIG. 4B shows the same lens system 50 as in FIG. 4A but also includes a listing of the surfaces in the system, as surfaces A, B, C, D, E, F, G, H, I and J. These 10 surfaces correspond to the surface data summary listed in FIG. 8 as surfaces 2 through 10 and the image standard (screen 59A). As shown, lens 53 includes surfaces A, B and C. Surface B is the cemented face of bonded lenses 51 and 52.

Surfaces D and E are the even asphere surfaces 5 and 6, respectively, of lens element 54. Surfaces F and G correspond to surfaces 7 and 8, respectively, of lens element 55. Surfaces H and I of prism element 59B correspond to surface 9 and 10, respectively, shown in FIG. 8. Finally, surface J of screen 59A corresponds to the image surface shown in FIG. 8. Including the EP 58, shown as the object and stop standard in FIG. 8, system 50 has 11 surfaces as tabulated in FIG. 8.

The various radii of the surfaces in system 50 are also tabulated in FIG. 8. It will be appreciated that an infinite radius is defined as a non-curved surface. The eye pupil 58 and the prism 59B includes non-curved surfaces. FIG. 8 also lists the thickness from one surface to the next surface. Some of the thicknesses includes the air-space between one lens element and another lens element.

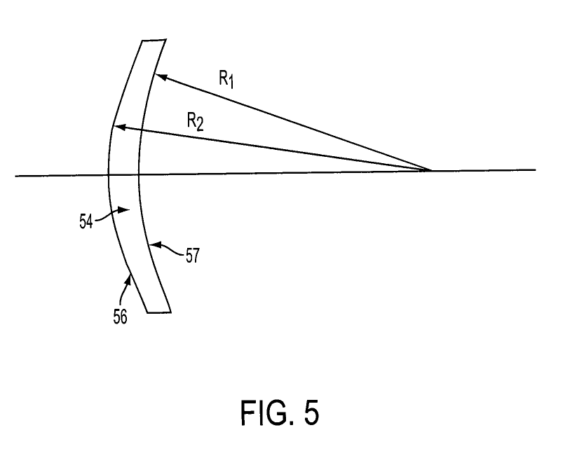

FIG. 5 shows a configuration of second lens element 54. As shown, R₂ is the radius of convex surface 56 of second lens element 54, and R₁ is the radius of second concave surface 57. The thickness of second lens element 54 is also tabulated in FIG. 8. It will be appreciated that a steeper convex surface 56 than that of concave surface 57 results in a positive power, as such, the center portion of second lens element 54 is thicker than the peripheral portions of the second lens element.

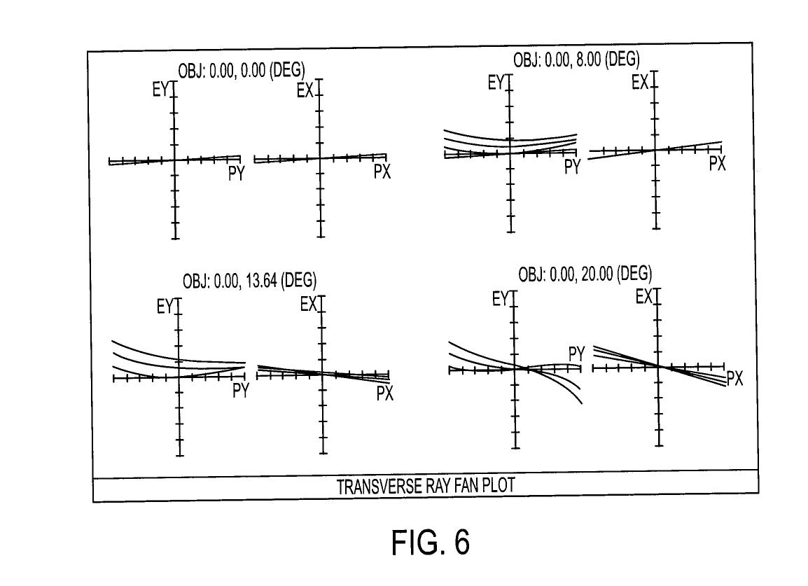

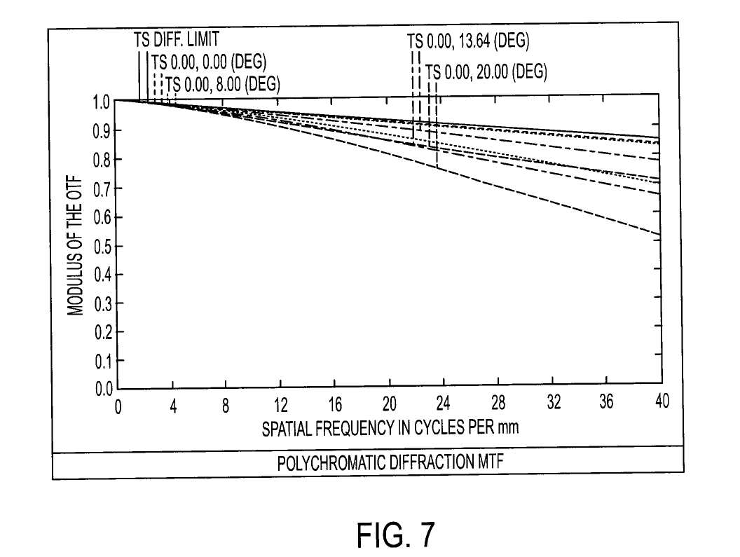

is Curved screen 59A, as described above, advantageously optimizes and balances the residual aberrations of astigmatism, distortion and lateral color. The result is a significantly improved level of performance, as demonstrated by FIGS. 6 and 7, which have been developed using ZEMAX® software by Focus Software, Inc.

FIG. 6 shows plots of aberrations (transverse ray fan plots, and field curvature/distortion, longitudinal spherical aberration and lateral chromatic aberration curves) for four field points of lens system 50. Each image height has two ray fan plots, respectively, corresponding to coma aberration on tangential planes PY and EY and sagittal planes PX and EX. Most of the image formation includes minimal magnification errors.

FIG. 7 is a modulation transfer function (MTF) distribution diagram of lens system 50. As shown, the transverse axis denotes spatial frequency, line pairs per mm (Ip/mm) and the longitudinal axis denotes MTF. The numerical value of the MTF represents imaging quality of the lens. The value range of the MTF is 0-1. The MTF curve in the tangential direction T is close to the sagittal direction in each field of view. This indicates that the performance of the lens is relatively consistent in the tangential and the sagittal directions in each field of view, which ensures an entirely clear and uniform imaging surface.

Referring now to the prescription of surface 5 and surface 6 of lens element 54, which are the even aspheric surfaces 56 and 57, respectively, an even polynomial asphere is defined by:

$$Z = \frac{{r}^{2} / R}{1 + \sqrt{1 - ( k + 1 ) {r}^{2} / {R}^{2}}} + A {r}^{4} + B {r}^{6} + C {r}^{8} + D {r}^{10}$$

where Z is the sagitta (or sag) of surfaces 56 and 57.

The first term in the equation describes a conic section. The other terms are even polynomial terms that describe the aspheric deviation from the conic section. The R is the radius of a sphere; and r is the radial coordinate. For illustration purpose, k=0 (for a sphere). As indicated in FIG. 8, the coefficients of the radial coordinate r for the four even aspheric terms of surface 56 are:
Coeff on r 4: 9.4861363e-006
Coeff on r 6: −2.5619494e-007
Coeff on r 8: 1.9985114e-009
Coeff on r 10: −6.8967227e-012

The coefficients of the radial coordinate r for the four even aspheric terms of the surface 57 are:
Coeff on r 4: 4.8535909e-005
Coeff on r 6: −2.4570981e-007
Coeff on r 8: 2.4279589e-009
Coeff on r 10: −7.9825147e-012

The lens system, or eyepiece, or magnifier disclosed in the present invention has various applications, for example, it may be used as a replacement eyepiece for PVS-7, MNVD, ENVG, LEGACY or COD Project.

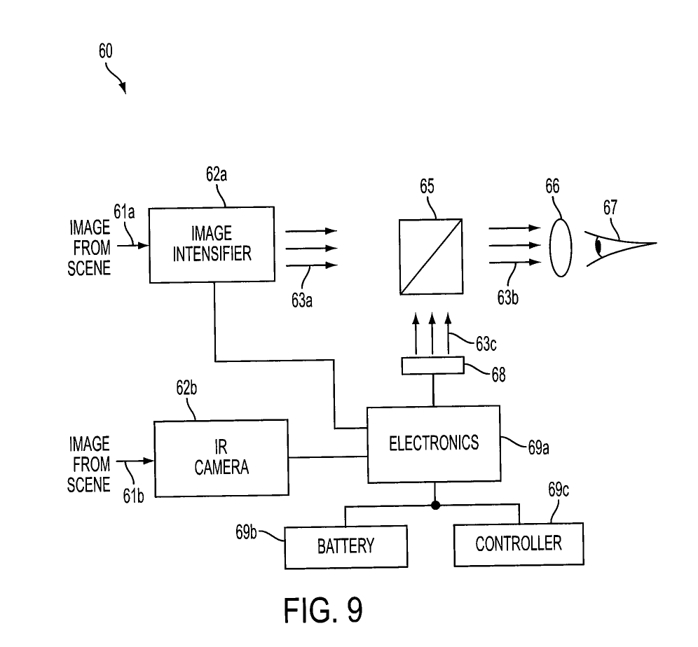

FIG. 9 shows an embodiment of the present invention in which lens system 50 is used. As shown, a night vision goggle (NVG) system, generally designated as 60, includes an image intensifier 62a, a second channel sensor, such as an infrared camera 62b, a beam combiner (or beamsplitter) 65 and an eyepiece 66 for viewing by eye 67. The lens 66, disposed between beam combiner 65 and eye 67, corresponds to lens system 50 shown in FIG. 4A.

The NVG system 60 includes image intensifier 62a which amplifies light 61a. The image intensitifier includes a photo-cathode that converts the light photons into electrons, a multi-channel plate (MCP) that accelerates the electrons and a phosphor screen that receives the accelerated electrons to form amplified light image 63a. The image formed by image intensifier 62a is directed to beamsplitter 65 or beam combiner 65.

The eyepiece 66 is substantially co-axial with image intensifier 62a and beamsplitter 65, but may also be offset with a non-linear optics path defined between the image intensifier and the beamsplitter.

As shown, the second channel sensor is an infrared (IR) camera 62b which receives a thermal image from IR light 61b. The optical axes of the IR camera and image intensifier are substantially aligned parallel to each other. The IR camera outputs a signal indicative of the thermal imge. An electronics unit 69a receives the output signal from the IR camera and projects the image onto display 68. The display 68 is configured to provide an infrared image along a camera output path 63c to beamsplitter 65, at a substantially right angle relative to the path of the image intensifier image 63a. The display 68 may be an emissive type, reflective type, or transmissive type and may include a fused image of the image intensifier and the IR camera.

The beamsplitter 65 includes a dichroic surface configured to pass the intensified image and the IR image along an output path 63b. The dichroic surface allows a percentage of light incident thereon to pass through, while reflecting the remainder of the light. For example, the dichroic surface may be configured to allow approximately 70-90 percent of the light incident thereon to pass through, while the remaining 10-30 percent is reflected.

Completing the description of FIG. 9, NVG system 60 includes electronics unit 69a, battery 69b and controller 69c. The electronics 69a is associated with the image intensifier, the infrared camera and the display 68. The battery supplies power to each of the components of the NVG system. The controller is configured to control the image intensifier and the infrared camera.

Although the invention is illustrated and described herein with references to specific embodiments, the invention is not intended to be limited to the details shown. Rather, various modifications may be made in the details within the scope and range of equivalents of the claims and without departing from the invention.

What is claimed is:

1. An eyepiece for a night vision goggle (NVG) system comprising:
a first lens element axially aligned with second and third lens elements, wherein
the first, second and third lens elements are sequentially positioned between a viewer and an object,
the first lens element is formed as a doublet having two cemented surfaces,
the second lens element includes a convex surface facing the doublet and a concave surface facing the third lens element, and
the third lens element includes a first convex surface facing the second lens element, and a second convex surface facing the object.

2. The eyepiece of claim 1, wherein
the second lens element has at least one lens surface composed of an aspheric surface.

3. The eyepiece of claim 1, wherein
the convex and concave surfaces of the second lens element form a nearly concentric shell with a nearly uniform cross section, effectively resulting in a constant internal stress and reduced warpage.

4. The eyepiece of claim 2, wherein
a peripheral portion of the aspheric surface has a sagittal depth that is greater than a sagittal depth of another portion of the aspheric surface.

5. The eyepiece of claim 2, wherein
the aspheric surface has a distance of more than seven diopters from the surface of the object.

6. The eyepiece of claim 2, wherein
the aspheric surface is formed on a positive surface of the second lens element.

7. The eyepiece of claim 1, wherein
the first lens element includes a convex surface facing the viewer, and a concave surface facing the second lens element.

8. The eyepiece of claim 1, wherein the doublet includes
a negative lens and a positive lens, the negative lens faces the viewer, and
the positive lens faces the second lens element.

9. The eyepiece of claim 1, wherein
the first, second and third lens elements include a positive refractive power.

10. The eyepiece of claim 1, wherein
an image screen is aligned axially along an optical axis of the first, second and third lens elements for projecting light from the image screen, in sequence, toward the third, the second, and the first lens elements and toward the viewer.

11. The eyepiece of claim 10, further comprising
a beam combiner provided between the third lens and the object, in axial alignment along the optical axis, and
a display provided substantially perpendicular to the optical axis,
wherein light is emitted from the display and redirected by the beam combiner for viewing by the viewer.

12. An eyepiece comprising:
a first lens element axially aligned with a second lens element and a third lens element;
the first, second and third lens elements are sequentially positioned between a viewer and an object;
the first lens element is formed as a doublet having two cemented surfaces;
the second lens element is a meniscus lens having at least one lens surface composed of an aspheric surface, wherein a peripheral portion of the aspheric surface has a sagittal depth that is greater than a sagittal depth at another portion of the aspheric surface,
the aspheric surface has a distance of more than seven diopters from the surface of the object, and
the convex and concave surfaces of the second lens element form a nearly concentric shell with a nearly uniform cross section, resulting in nearly constant internal stress;
the third lens element is a biconvex lens, and
the first, second and third lens elements include a positive refractive power.

13. The eyepiece of claim 12, wherein
the first lens element includes a convex surface facing the viewer, and a concave surface facing the second lens element.

14. The eyepiece of claim 12, wherein
the doublet includes a negative lens and a positive lens, the negative lens faces the viewer, and the positive lens faces the second lens element.

15. The eyepiece of claim 12, wherein
the aspheric surface is formed on a positive surface of the second lens element.

16. The eyepiece of claim 12, wherein
the second lens element includes two even aspheric surfaces comprised of only even coefficients.

17. The eyepiece of claim 12, wherein
the object includes an image projected onto a curved screen surface, and
a prism is interposed between the curved screen surface and the third lens element.

18. A night vision device including an image superimposed on a screen surface and an eye pupil (EP) plane for viewing the image, the night vision device including a lens system comprising:
first, second and third lens elements sequentially located on an axial line between the EP and the screen surface,
the first lens element including a doublet having two cemented lens elements,
the second lens element including two even aspheric surfaces forming a nearly concentric shell with a nearly uniform cross section, and
the third lens element including a biconvex lens of oppositely facing symmetrical surfaces.

19. The night vision device of claim 18 wherein
the screen surface is a curved surface, and
the two even aspheric surfaces are each formed from only even coefficients.

20. The night vision device of claim 18 wherein
the screen surface images a combined image, and
the combined image is formed by superimposing an image from a visual camera with an image from a thermal camera.
